(19) United States
(12) Patent Application Publication
(10) Pub. No.: US 2025/0112324 A1
(43) Pub. Date: Apr. 3, 2025

(54) BATTERY AND BATTERY PACK

(71) Applicant: MURATA MANUFACTURING CO., LTD., Kyoto (JP)

(72) Inventors: Rie WATANABE, Kyoto (JP); Yoshiichi HORIKOSHI, Kyoto (JP)

(21) Appl. No.: 18/804,649

(22) Filed: Aug. 14, 2024

(30) Foreign Application Priority Data
Sep. 29, 2023 (JP) 2023-170389

(51) Int. Cl. H01M 50/358; H01M 50/107; H01M 50/193; H01M 50/325; H01M 50/559; H01M 50/593

(52) U.S. Cl. CPC H01M 50/358; H01M 50/107; H01M 50/193; H01M 50/325; H01M 50/559; H01M 50/593

(57) ABSTRACT

A battery is provided and includes a battery assembly; an exterior body that has an opening at one end and houses the battery assembly; and a safety valve disposed at the opening, in which the safety valve includes an inner terminal positioned relatively inside and an outer terminal positioned relatively outside, the inner terminal includes an annular-in-plan-view thinned part located on an inner peripheral side with respect to an opening end of the opening, and is electrically connected to the battery assembly on an outer peripheral side with respect to the thinned part, and the outer terminal is fixed to the inner terminal in a state of being elastically deformed toward the inside of the exterior body on an inner peripheral side with respect to the thinned part, and is electrically connected to each other.

### CROSS REFERENCE TO RELATED APPLICATIONS

The present application claim priority to Japanese patent application no. 2023-170389, filed on Sep. 29, 2023, the entire contents of which are incorporated herein by reference.

### BACKGROUND

The present disclosure relates to a battery and a battery pack using the battery.

Batteries are capable of extracting energy generated via chemical change or the like as electric energy, and are used for various applications. For example, batteries are used in mobile devices such as mobile phones, smart phones, and notebook computers.

### SUMMARY

The present disclosure relates to a battery and a battery pack using the battery.

Batteries and battery packs may be provided with a mechanism for ensuring the safety thereof.

For example, a battery and a battery pack including a safety valve mechanism for inhibiting occurrence of a defect caused by a gas when an abnormality occurs in the battery and the gas is generated inside the battery can be considered. The inventors of the present application studied whether there is still room for development of a safety valve mechanism of a battery and a battery pack and found that there is still room for development, for example, of a safety valve capable of achieving current interruption or the like at the time of abnormality.

The present disclosure has been devised in view of the above problems and relates to providing a battery and a battery pack having a more suitable structure as a safety valve according to an embodiment.

The battery according to the present disclosure, in an embodiment, includes: a battery assembly; an exterior body that has an opening at one end and houses the battery assembly; and a safety valve disposed at the opening,
in which
the safety valve includes an inner terminal positioned relatively inside and an outer terminal positioned relatively outside,
the inner terminal includes an annular-in-plan-view thinned part located on an inner peripheral side with respect to an opening end of the opening, and is electrically connected to the battery assembly on an outer peripheral side with respect to the thinned part, and
the outer terminal is fixed to the inner terminal in a state of being elastically deformed toward the inside of the exterior body on an inner peripheral side with respect to the thinned part, and is electrically connected to each other.

Further, the battery pack according to the present disclosure, in an embodiment, includes: a battery; and a battery holder that houses the battery,
in which
the battery holder includes an opening and a safety valve provided in the opening,
the safety valve includes an inner terminal located relatively on an inner side of the battery holder, and an outer terminal located relatively on an outer side of the battery holder,
the inner terminal includes a thinned part extending on an inner peripheral side with respect to an opening end of the opening, and is electrically connected to the battery on an outer peripheral side with respect to the thinned part, and
the outer terminal is fixed to the inner terminal in a state of being elastically deformed toward the inside of the battery holder on an inner peripheral side with respect to the thinned part.

In the battery and the battery pack according to the present disclosure, in an embodiment, two terminals are incorporated in a safety valve. The battery and the battery pack of the present disclosure, in an embodiment, have a safety valve structure not seen before in that one of the terminals located outside the battery or the battery pack is fixed to the other terminal in a state of being elastically deformed inward. Such a configuration makes it possible to suitably cut off a current at the time of abnormality.

### BRIEF DESCRIPTION OF THE FIGURES

FIG. 1 is a schematic perspective view illustrating the appearance of a secondary battery according to an embodiment of the present disclosure;

FIG. 2 is a schematic perspective view illustrating the interior configuration of a secondary battery according to an embodiment of the present disclosure;

FIG. 3 is a schematic perspective view illustrating constituent members and related members of a safety valve of a secondary battery according to an embodiment of the present disclosure;

FIG. 4 is a schematic sectional view illustrating constituent members of a safety valve of a secondary battery according to an embodiment of the present disclosure;

FIG. 5 is a schematic sectional perspective view illustrating a state of a safety valve of a secondary battery according to an embodiment of the present disclosure before the operation thereof;

FIG. 6 is a schematic sectional view illustrating a state of a safety valve of a secondary battery according to an embodiment of the present disclosure before the operation thereof;

FIG. 7 is a schematic sectional view illustrating a state of a safety valve of a secondary battery according to an embodiment of the present disclosure after the operation thereof;

FIG. 8 is a schematic sectional view illustrating a safety valve of a secondary battery according to an embodiment of the present disclosure;

FIG. 9 is an exploded perspective view schematically illustrating an exterior body according to an embodiment of the present disclosure;

FIG. 10 is a schematic sectional view of a secondary battery according to an embodiment of the present disclosure;

FIG. 11 is a schematic sectional view of a battery pack according to an embodiment of the present disclosure;

FIG. 12 is a schematic sectional view illustrating a state of a safety valve of a battery pack according to an embodiment of the present disclosure before the operation thereof; and

FIG. 13 is a schematic sectional view illustrating a state of a safety valve of a battery pack according to an embodiment of the present disclosure after the operation thereof.

### DETAILED DESCRIPTION

In the following, one or more embodiments of the present disclosure will be described in further detail. The present disclosure is not particularly limited to the embodiments and the like described herein, and can be executed with appropriate modification. For the sake of easier explanation or understanding, the description may be separately given for embodiments including examples. However, the structures shown in separate embodiments including examples may be partly replaced or combined. In the description of such embodiments, redundant description of substantially the same matters may be omitted, and only different points may be described. Particularly, similar functions and effects achieved by similar configurations will not be mentioned for every embodiment.

Furthermore, in the description of the present specification, reference to a direction, a sense, or the like is merely for convenience of description, and is not intended to limit the scope of the present disclosure unless otherwise explicitly described. For example, relative terms such as “outer (or outside, outer part or outer periphery)” and “in (or inside, inner part or inner periphery)” and their derivatives should be interpreted to refer to directions as described or illustrated. Similarly, “above” with respect to an element includes not only a case of being in contact with an upper surface of the element but also a case of not being in contact with the upper surface of the element. In more detail, “above” with respect to an element includes not only an upper position away from the element, that is, an upper position with another object interposed therebetween on the element or an upper position at an interval, but also a position in contact with and immediately above the element. In addition, the term “above” does not necessarily mean the upper side in the vertical direction. The term “above” merely indicates a relative positional relationship of an element. That is, unless otherwise explicitly described, the invention is not required to be limited only to a specific direction, sense, form, or the like. In addition, the above applies similarly to terms such as “provided”, “disposed”, “connected”, and “attached”, and terms derived therefrom, and these are not limited to a direct mode, and may be a mode in which another element such as an intervening matter is interposed unless otherwise explicitly described.

The term “battery” as referred to herein encompasses not only a so-called “secondary battery” but also a “primary battery”, which can only be discharged. That is, the “battery” as referred to herein may be either a “secondary battery”, which can be repeatedly charged and discharged, or a “primary battery”, which is substantially only discharged. It is noted that the “secondary battery” is not excessively restricted to its name, and may include, for example, “power storage device”, and the like.

Hereinafter, for convenience of description, the battery according to the present disclosure will be described mainly by taking a secondary battery as an example.

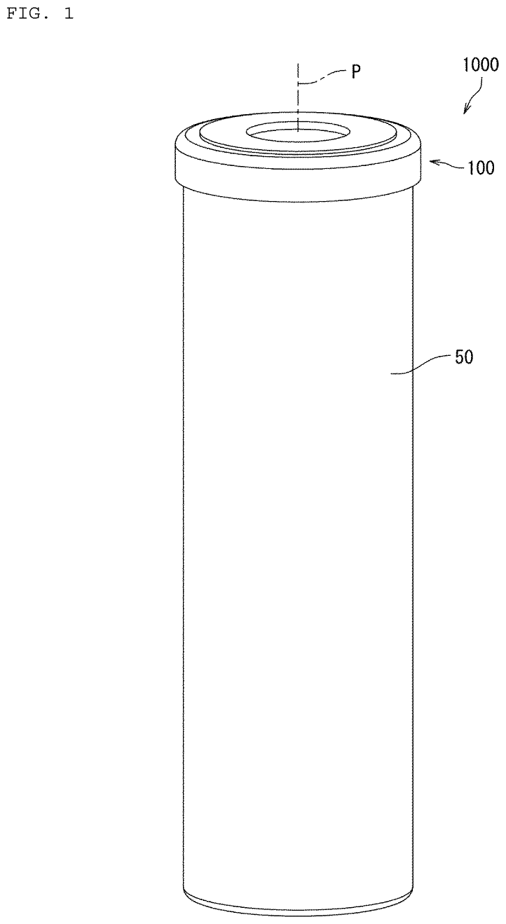

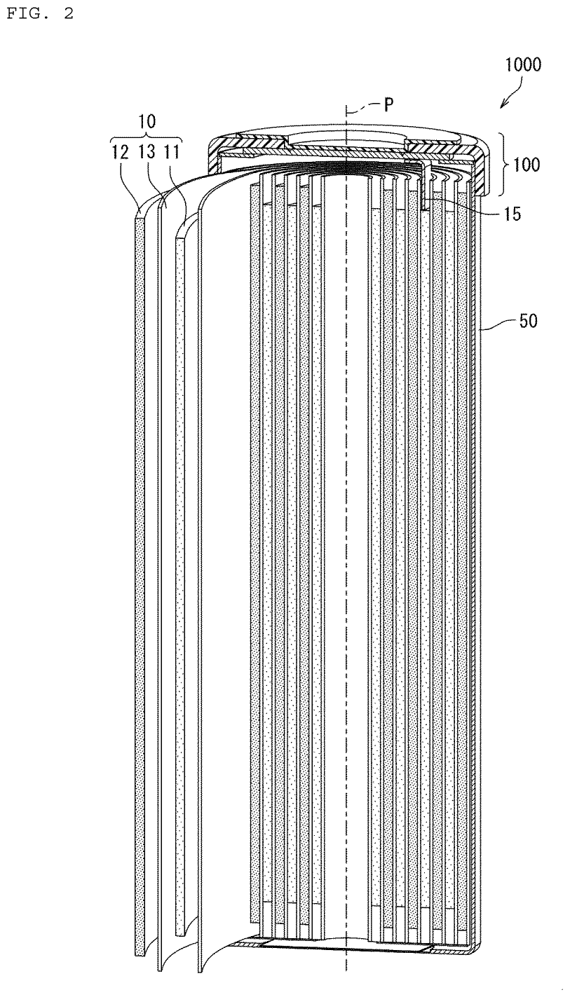

The secondary battery according to the present disclosure includes a battery assembly composed of an electrode-constituting layer including a positive electrode, a negative electrode, and a separator. The secondary battery according to the present disclosure may have a wound structure (hereinafter, also referred to as “wound electrode body” or “wound structure”) in which such an electrode-constituting layer is wound in a roll shape. FIG. 1 schematically illustrates an exemplary embodiment of the appearance of a secondary battery 1000, and FIG. 2 schematically illustrates an exemplary embodiment of the internal structure thereof. As illustrated in the drawings, a battery assembly 10 is housed inside an exterior body 50. In the exemplary embodiment illustrated in FIG. 2, the battery assembly 10 has a configuration in which a positive electrode 11, a negative electrode 12, and a separator 13 disposed between the positive electrode and the negative electrode are wound. For the secondary battery 1000, such a battery assembly 10 is enclosed together with an electrolyte (for example, a non-aqueous electrolyte) in an exterior body 50.

The positive electrode is composed of at least a positive electrode material layer and a positive electrode current collector. In the positive electrode, the positive electrode material layer is provided on at least one surface of the positive electrode current collector. The positive electrode material layer contains a positive electrode active material as an electrode active material. For example, for each of a plurality of positive electrodes in the battery assembly, the positive electrode material layer may be provided on both surfaces of the positive electrode current collector, or may be provided only on one surface of the positive electrode current collector.

The negative electrode is composed of at least a negative electrode material layer and a negative electrode current collector. In the negative electrode, the negative electrode material layer is provided on at least one surface of the negative electrode current collector. The negative electrode material layer contains a negative electrode active material as an electrode active material. For example, for each of a plurality of negative electrodes in the battery assembly, the negative electrode material layer may be provided on both surfaces of the negative electrode current collector, or may be provided only on one surface of the negative electrode current collector.

The electrode active materials contained in the positive electrode and the negative electrode, that is, the positive electrode active material and the negative electrode active material, respectively, are materials directly involved in transfer of electrons in the secondary battery, and are main materials of the positive and negative electrodes that are responsible for charge and discharge, that is, a battery reaction. More specifically, ions are brought in the electrolyte due to the “positive electrode active material contained in the positive electrode material layer” and the “negative electrode active material contained in the negative electrode material layer”, and such ions move between the positive electrode and the negative electrode to transfer electrons, thereby performing charging and discharging. The positive electrode material layer and the negative electrode material layer may be layers particularly capable of occluding and releasing lithium ions. More specifically, the secondary battery according to the present disclosure may be a non-aqueous electrolyte secondary battery in which lithium ions move between the positive electrode and the negative electrode through a non-aqueous electrolyte, thereby charging and discharging the battery. When lithium ions are involved in charging and discharging, the secondary battery according to the present disclosure corresponds to a so-called “lithium ion battery”, and has a layer capable of occluding and releasing lithium ions as the positive electrode and the negative electrode.

In view of a lithium ion battery, the positive electrode active material may be, for example, a material that contributes to occlusion and release of lithium ions. In other words, the positive electrode layer may contain any one kind or two or more kinds among positive electrode materials capable of occluding and releasing lithium. From such a viewpoint, the positive electrode active material may be, for example, a lithium-containing compound. The lithium-containing compound is not particularly limited in its type, and examples thereof include a lithium-containing composite oxide and a lithium-containing phosphate compound. This is because a high energy density is readily obtained.

The lithium-containing composite oxide is a generic name of oxides containing lithium and one or more of other elements (elements other than lithium) as constituent elements, and may have, for example, one of crystal structures such as a layered rock-salt type crystal structure and a spinel type crystal structure. The lithium-containing phosphate compound is a generic name of phosphate compounds that contain lithium and one or more of the other elements as constituent elements, and may have, for example, a crystal structure such as an olivine crystal structure. The kind of the other element is not particularly limited as long as the element is any one or two or more of arbitrary elements. Above all, the other element is preferably one or two or more of the elements belonging to Groups 2 to 15 in the long-period periodic table. More specifically, examples of the other element include nickel (Ni), cobalt (Co), manganese (Mn) and iron (Fe). This is because a high voltage can be easily obtained.

The lithium-containing composite oxide having a layered rock salt type crystal structure may be compounds represented by the following Formulas (1) to (3), respectively.

LiₐMn_{(1-b-c)}Ni_{b}M11_{c}O_{(2-d)}Fₑ (1)

(M11 is at least one element among cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W); a to e satisfy 0.8≤a≤1.2, 0<b<0.5, 0≤c≤0.5, (b+c)<1, −0.1≤d≤0.2, and 0≤e≤0.1, provided that the composition of lithium varies depending on the charged and discharged states, and a is a value of a fully discharged state).

LiₐNi_{(1-b)}M12_{b}O_{(2-c)}F_{d} (2)

(M12 is at least one element among cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); a to d satisfy 0.8≤a≤1.2, 0.005≤b≤0.5, −0.1≤c≤0.2, and 0≤d≤0.1, provided that the composition of lithium varies depending on the charged and discharged states, and a is a value of a fully discharged state).

LiₐCo_{(1-b)}M13_{b}O_{(2-c)}F_{d} (3)

(M13 is at least one element among nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); a to d satisfy 0.8≤a≤1.2, 0≤b<0.5, −0.1≤c≤0.2, and 0≤d≤0.1, provided that the composition of lithium varies depending on the charged and discharged states, and a is a value of a fully discharged state).

Specific examples of the lithium-containing composite oxide having a layered rock salt type crystal structure include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})O₂.

In a case in which the lithium-containing composite oxide having a layered rock-salt crystal structure contains nickel, cobalt, manganese, and aluminum as constituent elements, the atomic ratio of nickel is preferably 50 atomic % or more. This is because a high energy density is readily obtained.

The lithium-containing composite oxide having a spinel type crystal structure may be, for example, a compound represented by the following Formula (4).

LiₐMn_{(2-b)}M14_{b}O_{c}F_{d} (4)

(M14 is at least one element among cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); a to d satisfy 0.9≤a≤1.1, 0≤b≤0.6, 3.7≤c≤4.1, and 0≤d≤0.1, provided that the composition of lithium varies depending on the charged and discharged states, and a is a value of a fully discharged state).

Specific examples of the lithium-containing composite oxide having a spinel type crystal structure may include LiMn₂O₄.

The lithium-containing phosphate compound having an olivine type crystal structure may be, for example, a compound represented by the following Formula (5).

LiₐM15PO₄ (5)

(M15 is at least one element among cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr); a satisfies 0.9≤a≤1.1, provided that the composition of lithium varies depending on the charged and discharged states, and a is a value of a fully discharged state).

Specific examples of the lithium-containing phosphate compound having an olivine type crystal structure may include LiFePO₄, LiMnPO₄, LiFe_{0.5}Mn_{0.5}PO₄, and LiFe_{0.3}Mn_{0.7}PO₄.

Incidentally, the lithium-containing composite oxide may be a compound represented by the following Formula (6).

(Li₂MnO₃)ₓ(LiMnO₂)₁₋ₓ (6)

(x satisfies 0≤x≤1, provided that the composition of lithium varies depending on the charged and discharged states, and x is a value of a fully discharged state).

In addition to these, the positive electrode material may be any one kind or two or more kinds among, for example, oxides, disulfides, chalcogenides, and conductive polymers. Examples of the oxide may include titanium oxide, vanadium oxide, and manganese dioxide. Examples of the disulfide include titanium disulfide and molybdenum sulfide. The chalcogenide is, for example, niobium selenide or the like. The conductive polymer may be, for example, sulfur, polyaniline, polythiophene, or the like. However, the positive electrode material is not particularly limited, and may be a material other than the above materials.

The positive electrode material layer may contain a binder. In addition, a positive electrode conductor may be included in the positive electrode material layer to facilitate the transfer of electrons that promote a battery reaction. The positive electrode binder may contain, for example, any one or one or more types of synthetic rubbers and polymer compounds. The synthetic rubber is, for example, styrene-butadiene rubber, fluorine rubber, ethylene propylene diene, or the like. The polymer compound is, for example, polyvinylidene fluoride, polyimide, or the like. The positive electrode conductor may include, for example, any one of, or two or more of carbon materials. The carbon material may be, for example, graphite, carbon black, acetylene black, ketjen black, or the like. However, the positive electrode conductor may be a metal material, a conductive polymer and the like as long as they are materials exhibiting conductivity.

In a similar manner, the negative electrode active material of the negative electrode material layer may be a material that contributes to occlusion and release of lithium ions. In other words, the negative electrode layer may contain any one kind or two or more kinds among negative electrode materials capable of occluding and releasing lithium. From such a viewpoint, the negative electrode active material may be, for example, various carbon materials, metal-based materials, and/or other materials.

When a carbon material is used as the negative electrode active material, the carbon material causes an extremely-small change in a crystal structure thereof when lithium is inserted or extracted, which is readily stably achieve high energy density. Further, the carbon material serves also as a negative electrode conductive agent, so that conductivity of the negative electrode layer is readily improved.

Examples of a specific carbon material include graphitizable carbon, non-graphitizable carbon, and/or graphite. More specifically, the carbon material may be, for example, pyrolytic carbons, cokes, glassy carbon fiber, organic polymer compound fired body, activated carbon, carbon blacks, or the like. The cokes may include pitch coke, needle coke, and petroleum coke. The organic polymer compound fired body is, for example, a material obtained by firing (carbonizing) a polymer compound such as phenol resin and furan resin at appropriate temperature. In addition, the carbon material may be low crystalline carbon subjected to a heat treatment at a temperature of about 1000° C. or less, or may be amorphous carbon. The shape of the carbon material is not particularly restricted and may be at least one among a fibrous shape, a spherical shape, a granular shape, and a scaly shape.

The “metal-based material” to be used as the negative electrode active material is a generic term for materials containing any one kind or two or more kinds among metal elements and metalloid elements as constituent elements. When a carbon material is used as the negative electrode active material, a high energy density is readily obtained. The metal-based material may be a simple substance, an alloy, a compound, two or more of these, or a material at least a part of which has phases composed of one or one or more of these. However, the alloy may include a material containing one or more kinds of metal elements and one or more kinds of metalloid elements in addition to a material composed of two or more kinds of metal elements. The alloy may contain a non-metallic element. The construction of this metal-based material may be, for example, a solid solution, a eutectic (eutectic mixture), an intermetallic compound, and a material in which two or more kinds among these coexist. The metal element and metalloid element as described above may be, for example, any one kind or two or more kinds among metal elements and metalloid elements capable of forming an alloy with lithium. Specifically, the metal element and the metalloid element may be, for example, magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc, hafnium (Hf), zirconium, yttrium (Y), palladium (Pd), and/or platinum (Pt). In a preferred embodiment, the metal elements are silicon and tin. This is because the ability to occlude and release lithium is excellent and a significantly high energy density is readily attained. A material containing silicon as a constituent element may be a simple substance of silicon, an alloy of silicon, or a compound of silicon, may be two or more selected from among these materials, or may be a material including one or two or more phases thereof in at least a part thereof. Similarly, a material containing tin as a constituent element may be a simple substance of tin, an alloy of tin, or a compound of tin, may be two or more thereof, or may be a material including one or two or more phases thereof in at least a part thereof. The “simple substance” described herein is a simple substance in a general sense to the utmost, and thus the simple substance may contain a small amount of impurities. That is, the purity of the simple substance is not necessarily limited to 100%. The alloy of silicon may contain, for example, any one or two or more of tin, nickel, copper, iron, cobalt, manganese, zinc, indium, silver, titanium, germanium, bismuth, antimony, chromium, or the like as constituent elements other than silicon. The compound of silicon may contain, for example, any one or two or more of carbon, oxygen or the like as constituent elements other than silicon. The compound of silicon may contain, for example, any one or two or more of a series of elements described in the alloy of silicon as constituent elements other than silicon. Examples of the alloy of silicon and examples of the compound of silicon may include SiB₄, SiB₆, MgSi, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2), and/or LiSiO. In SiOᵥ, v may be 0.2<v<1.4. The alloy of tin may contain, for example, any one or two or more types of silicon, nickel, copper, iron, cobalt, manganese, zinc, indium, silver, titanium, germanium, bismuth, antimony, chromium, and the like, as constituent elements other than tin. The compound of tin may contain, for example, any one or two or more types of carbon, oxygen, and the like, as constituent elements other than tin. The compound of tin may contain any one or two or more of a series of elements described in the alloy of tin, for example, as constituent elements other than tin. Examples of the alloy of tin and Examples of the compound of tin include Snow (0<w≤2), SnSiO₃, LiSnO and/or Mg₂Sn. In particular, the material containing tin as a constituent element may be, for example, a material (tin-containing material) containing a second constituent element and a third constituent element together with tin which is a first constituent element. The second constituent element may be, for example, any one or two or more of cobalt, iron, magnesium, titanium, vanadium, chromium, manganese, nickel, copper, zinc, gallium, zirconium, niobium, molybdenum, silver, indium, cesium (Ce), hafnium (Hf), tantalum, tungsten, bismuth, silicon, or the like. The third constituent element may be, for example, any one or two or more of boron, carbon, aluminum, phosphorus, or the like. This is because a high battery capacity, excellent cycle characteristics and the like are readily attained. Among these, the tin-containing material may be a material containing tin, cobalt, and carbon as constituent elements (tin cobalt carbon-containing material). This is because a high energy density is readily obtained. In the tin cobalt carbon-containing material, at least a part of carbon which is a constituent element may be bonded to a metal element or metalloid element which is another constituent element. This is because this facilitates inhibition of the aggregation of tin, crystallization of tin, and the like. Such a tin cobalt carbon-containing material is not limited to the material (SnCoC) that contains only tin, cobalt, and carbon as constituent elements. This tin cobalt carbon-containing material may further contain, for example, any one or two or more of silicon, iron, nickel, chromium, indium, niobium, germanium, titanium, molybdenum, aluminum, phosphorus, gallium, bismuth or the like as a constituent element in addition to tin, cobalt, and carbon. In addition to the tin cobalt carbon-containing material, a material containing tin, cobalt, iron, and carbon as constituent elements (tin cobalt iron carbon-containing material) is also available.

In addition to these, the negative electrode material may be any one kind or two or more kinds among, for example, metal oxides and polymer compounds. Examples of the metal oxide may include iron oxide, ruthenium oxide, and molybdenum oxide. Examples of the polymer compound may include polyacetylene, polyaniline, and polypyrrole.

The negative electrode material layer may contain a binder. Furthermore, a negative electrode conductive agent may be included in the negative electrode material layer in order to facilitate the transfer of electrons that promotes a battery reaction. The binder which can be contained in the negative electrode material layer is not particularly limited, but examples thereof include at least one kind selected from the group consisting of styrene-butadiene rubber, polyacrylic acid, polyvinylidene fluoride, polyimide-based resin, and polyamideimide-based resin. The negative electrode conductive agent that may be contained in the negative electrode material layer is not particularly limited, but examples thereof may include at least one selected from carbon blacks such as thermal black, furnace black, channel black, ketjen black, and acetylene black, carbon fibers such as graphite, carbon nanotube, and vapor-grown carbon fiber, metal powders such as copper, nickel, aluminum and silver, and polyphenylene derivatives. It is to be noted that the negative electrode material layer may include therein a component derived from a thickener component (for example, a carboxymethyl cellulose) used at the time of manufacturing the battery.

The positive electrode current collector and the negative electrode current collector used for the positive electrode and the negative electrode are members configured to contribute to collecting and supplying electrons generated in the electrode active material due to the battery reaction. Such an electrode current collector may be a sheet-shaped metal member. This electrode current collector may have either a single layer or multiple layers. Furthermore, the electrode current collector may have a porous or perforated form. For example, the current collector may be a metal foil, a punching metal, a net, an expanded metal, or the like. The positive electrode current collector that is used for the positive electrode may be made of, for example, a metal foil containing at least one selected from the group consisting of aluminum, nickel, stainless steel, and the like. Meanwhile, the negative electrode current collector that is used for the negative electrode may be made of, for example, a metal foil containing at least one selected from the group consisting of copper, aluminum, nickel, stainless steel, and the like.

The separator used for the positive electrode and the negative electrode is a member provided from the viewpoints of the prevention of short circuit due to contact between the positive and negative electrodes and the holding of the electrolyte and the like. In other words, the separator is a member that separates the positive electrode from the negative electrode and allows ions (e.g., lithium ions) to pass therethrough while preventing current short circuit resulting from contact of the positive electrode and the negative electrode. For example, the separator may be a porous or microporous insulating member, which may have a film form due to its small thickness.

The separator may be, for example, any one kind or two or more kinds among porous films of synthetic resins and/or ceramics and the like, and may be a laminated film of two or more kinds of porous films. The synthetic resin to be used for the separator is, for example, polytetrafluoroethylene, polypropylene, polyethylene, or the like. For example, the separator may include a porous film (substrate layer) and a polymer compound layer provided on one side or both sides of the substrate layer. This is because the close contact property of the separator with respect to the positive electrode is improved as well as the close contact property of the separator with respect to the negative electrode is improved, and thus the distortion of the wound electrode body is readily suppressed. The polymer compound layer may contain, for example, any one or two or more types of polymer compounds such as polyvinylidene fluoride. This is because the polymer compound layer is excellent in physical strength and becomes ready to be electrochemically stable. It should be understood that the polymer compound layer may contain any one or two or more types of insulating particles such as an inorganic particle. The kind of inorganic particles may be, for example, aluminum oxide and/or aluminum nitride. Further, in the present disclosure, the separator is not to be particularly limited by its name, and may be solid electrolytes, gel electrolytes, and/or insulating inorganic particles that have a similar function.

In the secondary battery of the present disclosure, the battery assembly including the electrode-constituting layer including the positive electrode, the negative electrode, and the separator may be enclosed in the exterior body together with an electrolyte. The electrolyte may be a so-called “non-aqueous” electrolyte.

The electrolyte, typically, the electrolytic solution contains a solvent and an electrolyte salt. The electrolytic solution may further contain any one or two or more of other materials such as additives. In a preferred embodiment, the separator may be impregnated with an electrolytic solution, and the positive electrode and/or the negative electrode may also be impregnated with an electrolytic solution.

The solvent may contain any one or two or more of non-aqueous solvents such as organic solvents. An electrolytic solution containing a non-aqueous solvent can be a so-called non-aqueous electrolytic solution. Examples of the non-aqueous solvent include a cyclic carbonate ester, a chain carbonate ester, a lactone, a chain carboxylate ester, and/or a nitrile (e.g., mononitrile). This is because more enhanced battery capacity, cycle characteristics and/or storage characteristics can be readily obtained. The cyclic carbonate ester may be, for example, ethylene carbonate, propylene carbonate, and/or butylene carbonate. The chain carbonate ester may be, for example, dimethyl carbonate, diethyl carbonate, ethyl methyl carbonate, and/or methyl propyl carbonate. The lactone may be, for example, γ-butyrolactone and/or γ-valerolactone. The chain carboxylate ester may be, for example, methyl acetate, ethyl acetate, methyl propionate, ethyl propionate, methyl butyrate, methyl isobutyrate, methyl trimethylacetate, and/or ethyl trimethylacetate. The nitrile may be, for example, acetonitrile, methoxyacetonitrile, and/or 3-methoxypropionitrile. Examples of the non-aqueous solvent may include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, and/or dimethyl sulfoxide. Among these, the non-aqueous solvent preferably contains one or two or more of ethylene carbonate, propylene carbonate, dimethyl carbonate, diethyl carbonate, ethyl methyl carbonate and the like. This is because higher battery capacity, more enhanced cycle characteristics, and/or more enhanced storage characteristics and the like can be readily obtained. Furthermore, the non-aqueous solvent may be, for example, an unsaturated cyclic carbonate ester, a halogenated carbonate ester, a sulfonate ester, an acid anhydride, a dicyano compound (dinitrile compound), a diisocyanate compound, a phosphate ester, and/or a chain compound having a carbon-carbon triple bond. This is because chemical stability of the electrolytic solution is readily improved. The “unsaturated cyclic carbonate ester” referred to herein is a cyclic carbonate ester having one or two or more unsaturated bonds (carbon-carbon double bonds or carbon-carbon triple bonds). Examples of this unsaturated cyclic carbonate ester include vinylene carbonate, vinyl ethylene carbonate, and/or methylene ethylene carbonate. The “halogenated carbonate ester” is a cyclic or chain carbonate ester having one or two or more halogen elements as constituent elements. In a case in which the halogenated carbonate ester contains two or more halogens as a constituent element, the kind of the two or more halogens may be one kind or two or more kinds. Examples of the cyclic halogenated carbonate ester include 4-fluoro-1,3-dioxolan-2-one and/or 4,5-difluoro-1,3-dioxolan-2-one. The chain halogenated carbonate ester may be, for example, fluoromethyl methyl carbonate, bis(fluoromethyl) carbonate, and/or difluoromethyl methyl carbonate. The sulfonate ester may be, for example, a monosulfonate ester and/or a disulfonate ester. The monosulfonate ester may be a cyclic monosulfonate ester or a chain monosulfonate ester. The cyclic monosulfonate ester may be, for example, sultones such as 1,3-propane sultone and/or 1,3-propene sultone. Examples of the chain monosulfonate ester include a compound in which a cyclic monosulfonate ester is cleaved in the middle. The disulfonate ester may be either a cyclic disulfonate ester or a chain disulfonate ester. The acid anhydride may be, for example, a carboxylic acid anhydride, a disulfonic acid anhydride and/or a carboxylic acid sulfonic acid anhydride. The carboxylic acid anhydride may be, for example, succinic anhydride, glutaric anhydride and/or maleic anhydride. The disulfonic acid anhydride may be, for example, ethanedisulfonic anhydride and/or propanedisulfonic anhydride. The carboxylic acid sulfonic acid anhydride may be, for example, sulfobenzoic anhydride, sulfopropionic anhydride and/or sulfobutyric anhydride. The dinitrile compound is, for example, a compound represented by NC—R1-CN (R1 represents either of an alkylene group or an arylene group). Examples of the dinitrile compound may include succinonitrile (NC—C₂H₄—CN), glutaronitrile (NC—C₃H₆—CN), adiponitrile (NC—C₄H₈—CN), and phthalonitrile (NC—C₆H₄—CN). The diisocyanate compound is, for example, a compound represented by OCN—R2-NCO (R2 represents either of an alkylene group or an arylene group). The diisocyanate compound may be, for example, hexamethylene diisocyanate (OCN—C₆H₁₂—NCO). Examples of the phosphate ester may include trimethyl phosphate and triethyl phosphate. A chain compound having a carbon-carbon triple bond is a chain compound having one or two or more carbon-carbon triple bonds (—C≡C—). Examples of this chain compound having a carbon-carbon triple bond may include propargyl methyl carbonate (CH≡C—CH₂—O—C(═O)—O—CH₃) and propargyl methanesulfonate (CH≡C—CH₂—O—S(═O)₂—CH₃).

For example, the electrolyte salt contained in the electrolytic solution may contain any one or two or more of salts such as lithium salts. The electrolyte salt may contain a salt other than lithium salts, for example. Such a salt other than lithium may be, for example, salts of light metals other than lithium. Examples of the lithium salts include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and/or lithium bromide (LiBr). This is because more enhanced battery capacity, cycle characteristics and/or storage characteristics can be readily obtained. Among these, any one kind or two or more kinds among lithium hexafluorophosphate, lithium tetrafluoroborate, lithium perchlorate, and lithium hexafluoroarsenate may be employed.

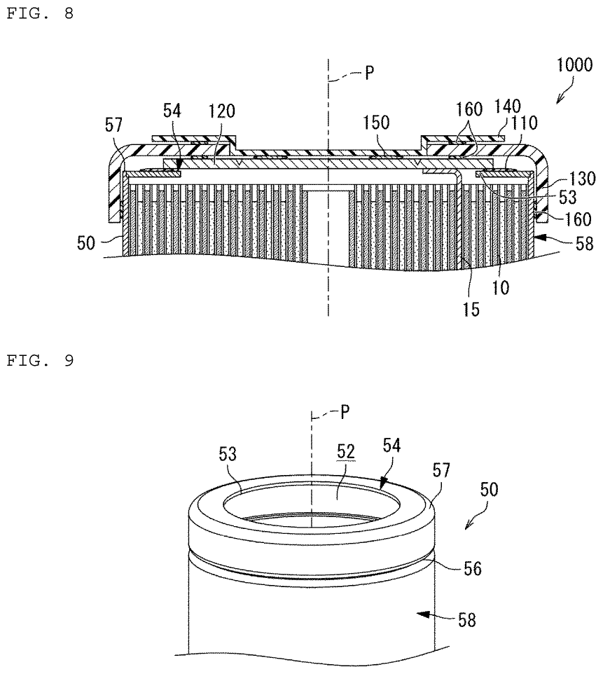

The exterior body 50 to be used for the secondary battery corresponds to a member that encloses a battery assembly formed by stacking electrode-constituting layers including a positive electrode, a negative electrode, and a separator as a battery exterior body. Such an exterior body 50 may also be referred to as, for example, a “battery can”. For example, the exterior body 50 may have a hollow structure in which one end is closed and an opening 52 is provided at the other end (see FIGS. 3 and 9). The opening 52 may be a through hole formed in one end of the exterior body 50. The exterior body is not particularly limited, but may be a metal can containing any one or two or more of metal materials such as iron, aluminum, stainless steel, and alloys thereof. The surface of the exterior body may be plated, for example, with any one or two or more of metal materials such as nickel. The opening 52 of the exterior body may be provided with a safety valve. Although being merely an example, the safety valve may be provided in the opening 52 of the exterior body together with a thermosensitive resistive device or the like.

The battery of the present disclosure has features related to a safety valve provided therein according to an embodiment. In particular, the present disclosure is characterized with respect to a safety valve provided on the exterior body (in particular, its opening) of the battery. Hereinafter, the battery of the present disclosure will be described taking a secondary battery as an example.

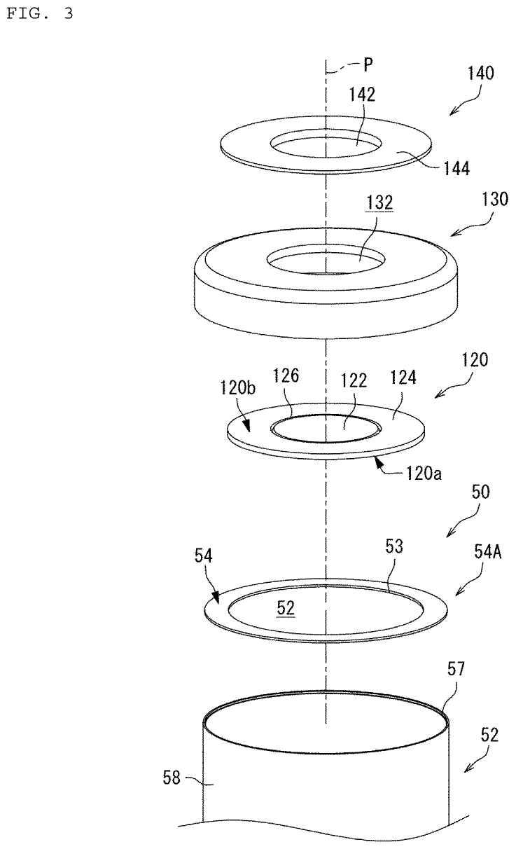

FIGS. 1 and 2 schematically show the appearance of the battery of the present disclosure and a sectional view thereof. As illustrated, the battery 1000 of the present disclosure may be a cylindrical battery (for example, a cylindrical non-aqueous secondary battery). In other words, the battery of the present disclosure may include a cylindrical case, namely, a cylindrical exterior body 50. The safety valve 100 may be provided at a cylinder end of the battery 1000 (particularly, an opening side end of the exterior body). FIG. 3 illustrates the safety valve 100 in a developed state together with its related members (or peripheral members), and FIG. 4 illustrates each constituent member of the safety valve 100 as a half perspective view.

The safety valve 100 provided in the battery of the present disclosure has at least a configuration in which a sealing member 110, a first terminal 120, an insulating member 130, and a second terminal 140 are combined in this order along a battery axis P. In the present specification, the “battery axis” refers to an axis that passes through the center of the exterior body 50 and is perpendicular to an extending direction of an end face of the exterior body (particularly, an end face on an imaginary plane). That is, the “battery axis” can mean an axis passing through the center of the exterior body 50 in plan view in which the battery is captured from the end side of the exterior body 50 on which the safety valve 100 is disposed. For example, the “battery axis” can also be understood as an axis which passes through the center of the exterior body 50 and extends in a direction orthogonal to the extending direction of the safety valve 100.

The safety valve of the present disclosure includes a first terminal 120 located relatively inside and a second terminal 140 located relatively outside. In other words, the safety valve includes the first terminal 120 located relatively inside in the battery axis direction and the second terminal 140 located relatively outside in the battery axis direction. The first terminal 120 and the second terminal 140 can also be referred to as an “inner terminal 120” and an “outer terminal 140”, respectively, from their relative positional relationship. The first terminal 120 includes an annular-in-plan-view thinned part 126 on the inner peripheral side of the opening end 53 of the opening of the exterior body. The thinned part 126 may be formed in a substantially annular shape on the inner peripheral side of the opening end 53 so as to be similar to the plan view shape of the opening end 53. Hereinafter, in the first terminal 120, the inner peripheral side of the thinned part 126 is referred to as a central part 122 of the first terminal, and the outer peripheral side of the thinned part 126 is referred to as an outer peripheral part 124 of the first terminal. In the present specification, the “inner peripheral side” can be interpreted as a side relatively proximal to the battery axis P, and the “outer peripheral side” can be interpreted as a side relatively distal to the battery axis P. At the outer peripheral part 124 on the outer peripheral side of the thinned part 126, the first terminal 120 is electrically connected to the battery assembly 10 housed in the exterior body 50 with a conductive member 15 interposed therebetween. The second terminal 140 is fixed to the first terminal 120 in a state of being elastically deformed toward the inside of the exterior body 50 on the inner peripheral side of the thinned part 126. With such fixing, the battery assembly 10, the first terminal 120, and the second terminal 140 are electrically connected to each other. That is, the first terminal 120 and the second terminal 140 have the same polarity.

Since the second terminal 140 is fixed to the first terminal 120 in a state of being elastically deformed toward the inside of the exterior body 50, a restoring force with which the elastically deformed second terminal 140 tends to return to the original state (namely, the exterior body 50 tends to be displaced toward the outside) acts on a part of the first terminal 120 to which the second terminal 140 is fixed. Due to the restoring force, the central part 122 of the first terminal receives a force with which the central part 122 is pulled toward the outer side of the exterior body 50 by the second terminal 140 fixed to the central part 122 in a state of being elastically deformed.

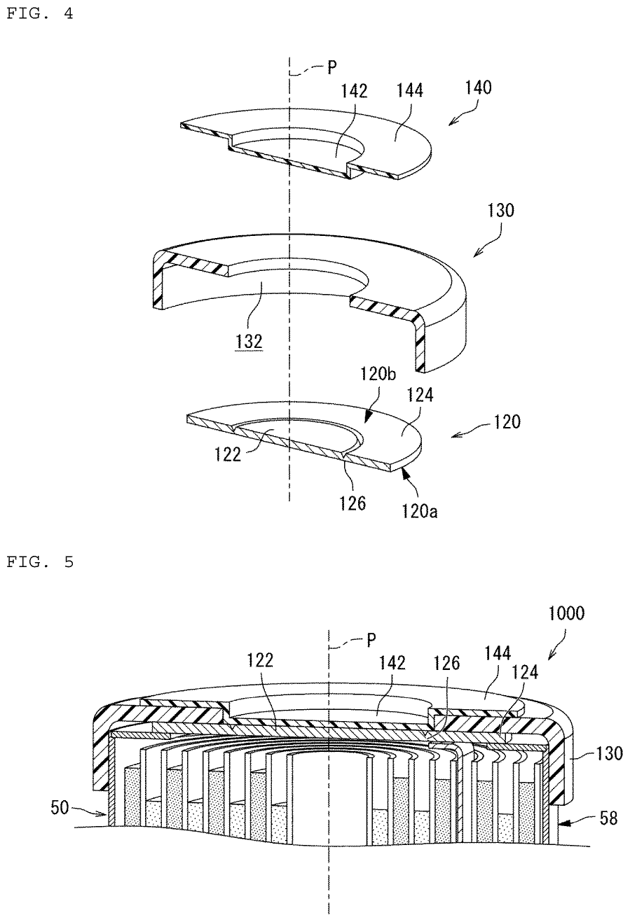

Here, the effect of the present disclosure will be described in more detail in connection with the abnormality of the secondary battery. FIGS. 5 and 6 are schematic sectional views of the battery in a normal state. The “normal state” indicates a state in which the internal pressure of the battery, namely, the internal pressure of the exterior body 50 is in a normal range, and the safety valve is not operating. As illustrated in the drawings, the second terminal 140 is fixed to the central part 122 of the first terminal in a state where a part of the second terminal 140 is elastically deformed toward the inside of the exterior body 50. In this state, the battery assembly and the second terminal 140 are electrically connected to each other with the thinned part 126 of the first terminal interposed therebetween.

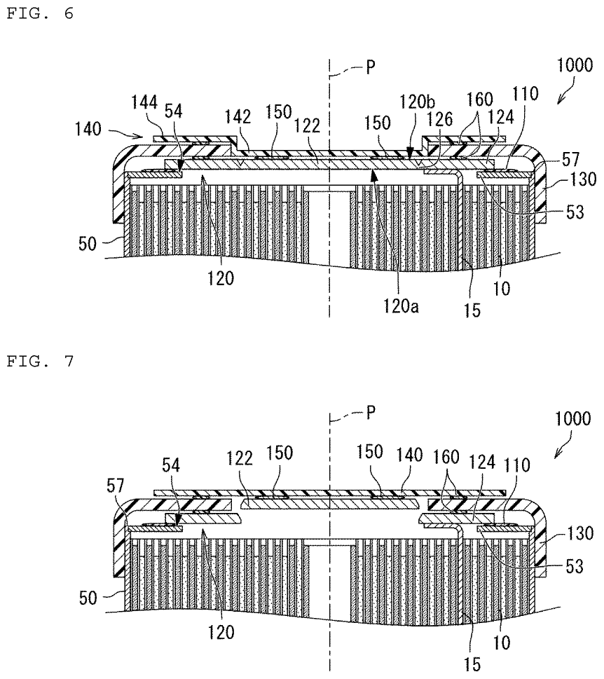

FIG. 7 is a schematic sectional view illustrating the battery after the safety valve 100 operated. On the other hand, when gas is generated due to overcharge of the battery or an undesired side reaction such as a decomposition reaction of the electrolytic solution inside the exterior body 50, the gas is accumulated in the exterior body 50, so that the internal pressure of the exterior body 50 increases. In addition, an increase in the internal pressure of the exterior body 50 may also be caused by an undesired temperature increase in the inside of the battery such as a short circuit. When the internal pressure of the exterior body 50 exceeds a certain prescribed pressure, the first terminal 120 is cleaved and divided as illustrated in FIG. 7. Specifically, when the internal pressure increases, the first terminal 120 is cleaved and divided at the thinned part 126 due to its thinness (small thickness). That is, when the internal pressure exceeds a prescribed pressure, the first terminal 120 is cleaved and divided at the thinned part 126 between the central part 122 to which the second terminal 140 is fixed and the outer peripheral part 124 electrically connected to the battery assembly 10. Alternatively, when cleavage (cracking) occurs in the thinned part 126 of the first terminal and a current path from the battery assembly to the second terminal 140 narrows, current concentration occurs in the thinned part 126. Due to the current concentration, the temperature of the thinned part 126 rises, and the thinned part 126 can be fused. As a result, the first terminal can be divided and/or fused into the central part 122 and the outer peripheral part 124. As a result, the central part 122 of the first terminal is physically separated from the outer peripheral part 124 on the outer peripheral side of the central part 122, and can be electrically disconnected. That is, due to the increase in the internal pressure, the first terminal 120 is divided into the central part 122 electrically connected to the second terminal 140 and the outer peripheral part 124 electrically connected to the battery assembly 10, and the electrical connection between the second terminal 140 and the battery assembly 10 can be cut off.

As described above, the first terminal 120 is cleaved at the thinned part 126 due to the increase in the internal pressure of the battery, so that the electrical connection from the battery assembly 10 to the second terminal 140 is disconnected. As a result, it is possible to stop the side reaction accompanied by generation of an undesired gas in the battery. At this time, owing to the structure of the present disclosure, it is possible to more reliably cleave and divide the first terminal 120 at the time of abnormality by using the restoring force of the elastically deformed second terminal 140. Specifically, in the safety valve 100 of the present disclosure, the first terminal 120 receives a restoring force with which the elastically deformed second terminal 140 tends to be displaced toward the outside of the exterior body 50. When the internal pressure rises at the time of abnormality, the restoring force has an effect of promoting cleavage of the first terminal 120. Specifically, when the internal pressure of the battery abnormally rises, the second terminal 140 itself is displaced toward the outer side of the battery along the battery axis direction. Since the second terminal 140 is fixed to the first terminal at the central part 122, the central part 122 of the first terminal is pulled out along with the displacement, and the central part 122 can be displaced toward the outer side of the battery together with the elastically deformed part of the second terminal 140.

In the safety valve 200 operated in this manner, the first terminal is divided into the central part 122 and the outer peripheral part 124, and the central part 122 and the outer peripheral part 124 are not positioned on the same plane but are positioned offset from each other in the battery axis direction. Therefore, in the safety valve after operation, the central part 122 and the outer peripheral part 124 of the first terminal are more reliably separated from each other.

In the safety valve of the present disclosure, when the internal pressure of the battery increases, both a force of pushing out from the inner side of the battery toward the outer side along with the increase in the internal pressure and a force of pulling toward the outer side of the battery due to the restoring force of the second terminal 140 act on the first terminal 120. By applying the two forces to the first terminal 120, the current can be more reliably cut off at the first terminal 120.

In addition, according to the present disclosure, the first terminal 120 is cleaved and/or divided not only by the pushing force acting from the inner side of the exterior body due to the increase in the internal pressure of the exterior body 50 but also by the pulling force acting from the outer side of the exterior body due to the restoring force of the second terminal 140. Therefore, the first terminal can be cleaved and/or divided also at a lower internal pressure. As a result, when an abnormality such as an increase in the internal pressure occurs in the battery, it is possible to operate the safety valve for cutting off the current earlier. Therefore, according to the present disclosure, a battery having more enhanced safety is provided.

Hereinafter, each member constituting the safety valve of the present disclosure will be described in more detail with reference to drawings.

The first terminal 120 is provided so as to close the opening 52 of the exterior body. For example, the first terminal 120 may overlap the end face 54 of the exterior body so as to cover the opening 52 of the exterior body. An insulative sealing member 110 is disposed between the exterior body 50 and the first terminal 120. The exterior body 50 and the first terminal 120 may be electrically insulated by the sealing member 110.

The first terminal 120 may have a substantially flat plate shape as a whole. For example, the first terminal 120 may have a form extending on the same plane. For example, the first terminal 120 may have a substantially constant thickness except for the thinned part 126.

A planar shape of the first terminal 120, in particular, a contour shape in plan view (hereinafter, also referred to as a “plan-view contour shape”) is not particularly limited, and may be, for example, a circular shape, a polygonal shape, or other shapes. The circular shape is, for example, a true circle (perfect circle), an ellipse, a substantial circle, or the like. The substantial circle is, for example, a generic name of a partly or overall distorted shape of a true circle. The polygons are, for example, triangle, quadrangles, pentagons, and hexagons. The other shapes are, for example, shapes other than a circular shape whose contour is formed only by a curve, shapes in which two or more types of polygons are combined, and shapes in which one or more types of circular shapes and one or more types of polygons are combined. The definitions of the “circular shape” and the like apply hereinafter. In the illustrated exemplary embodiment, the first terminal 120 has a circular plan-view contour shape. The “plan view” in the present disclosure is based on a sketch drawing when an object is viewed along the battery axis direction.

The first terminal 120 may be a metal member. For example, the first terminal 120 may contain a metal material containing at least one selected from the group consisting of aluminum (aluminum alloys, such as A1050, A3203, and A5052), nickel, titanium, platinum, copper, gold, stainless steel, and the like. In other words, the first terminal 120 may be a member made of such a conductive material. The material of the first terminal 120 may be the same as or different from the material of the second terminal 140.

The first terminal 120 includes a first surface 120a facing the inner side of the exterior body 50 and a second surface 120b located on the opposite side of the first surface 120a. The first terminal 120 includes a thinned part 126 on the first surface 120a and/or the second surface 120b. The “thinned part” refers to a part where the thickness of the first terminal 120 is locally reduced in sectional view. That is, the “thinned part” has a thickness smaller than the thickness of the other part of the first terminal 120. Therefore, the thinned part can also be referred to as a “relative thickness-reduced part” or the like. More specifically, the “thinned part” is a part having a thickness of 5% or more and 70% or less of the thickness of the part of the first terminal 120 on the battery axis P. For example, the thinned part 126 may be formed by a groove formed on the first surface 120a and/or the second surface 120b of the first terminal. With such a structure, when the internal pressure of the exterior body 50 is increased at the time of abnormality, the first terminal 120 can be cleaved at the thinned part 126.

A sectional shape of the thinned part 126 is not particularly limited. For example, a sectional shape of the first terminal 120 in the thinned part 126 (in particular, a sectional view shape of a hollow part affording the thinned part 126) may be a curved shape such as a substantially V-shape, a rectangular shape, a polygonal shape, or a substantially U-shape. Alternatively, the sectional shape may be a shape in which two or more arbitrary shapes among a rectangle, a polygon, and a curved shape, and so on are combined. Note that the term “sectional shape” in the present specification means a shape of a section taken when the first terminal 120 is cut along the thickness direction.

The thinned part 126 may extend along the opening end 53 of the exterior body on the inner peripheral side of the opening end 53. The thinned part 126 may have an annular shape in plan view. That is, the thinned part 126 may extend annularly along the opening end 53 to surround the battery axis P. The term “annular” in the present specification means a so-called ring shape. Therefore, the shape formed by the thinned part 126 is not necessarily circular, and may be an arbitrary shape such as a polygonal shape. In addition, the “annular shape” does not necessarily have to be a shape in which the entire circumference is fully closed, and may be interrupted in part. For example, the thinned part 126 may be formed intermittently along the opening end 53 of the exterior body, or may extend continuously along the opening end 53 of the opening.

The first terminal 120 may be electrically connected to the conductive member 15 extending from the battery assembly 10 at the outer peripheral part 124. More specifically, the first terminal 120 is in physical contact with the conductive member 15 extending from the battery assembly at the outer peripheral part 124 of the first surface 120a, and is electrically connected to the battery assembly. The first terminal 120 is electrically connected to the second terminal 140 at the central part 122 of the second surface 120b. That is, the battery assembly 10 and the second terminal 140 are electrically connected to each other with the first terminal 120 interposed therebetween. The thinned part 126 is positioned between a connection part between the battery assembly 10 and the first terminal 120 and a connection part (fixed part 150) between the first terminal 120 and the second terminal 140. Therefore, it can be interpreted that the battery assembly 10 and the second terminal 140 are electrically connected with the thinned part 126 of the first terminal interposed therebetween. With such a configuration, when the first terminal 120 is cleaved at the thinned part 126, the electrical connection between the battery assembly 10 and the second terminal 140 is cut off.

An insulative sealing member 110 is disposed between the exterior body 50 and the first terminal 120. The sealing member 110 seals between the exterior body 50 and the first terminal 120, and electrically insulates the exterior body 50 from the first terminal 120. The sealing member 110 may have a loop shape or a ring shape in plan view having a through hole similar to the opening shape of the opening of the exterior body. That is, the sealing member 110 is an annular insulating member 130 disposed to be interposed between the end face 54 of the exterior body and the first terminal 120 at the end part of the exterior body 50 including the opening.

### (Second Terminal)

The second terminal 140 may be disposed to overlap the first terminal 120 to cover the opening 52 of the exterior body. The planar shape of the second terminal 140, in particular, the contour shape in plan view of the second terminal 140 is not particularly limited, and may be, for example, a circular shape, a polygonal shape, another shape, or the like. The second terminal 140 may be a metal member that is elastically deformable by external pressure and is superior in conductivity. For example, the second terminal 140 may contain a metal material containing at least one selected from the group consisting of aluminum (aluminum alloys, such as A1050, A3203, and A5052), nickel, titanium, platinum, copper, gold, stainless steel, and the like. In other words, the second terminal 140 may be a member made of such a conductive material.

The thickness of the second terminal 140 is not particularly limited as long as the second terminal 140 is elastically deformable in the battery axis direction, and may be 0.20 mm or less, 0.18 mm or less, or 0.15 mm or less when it is emphasized that the restoring force from the elastically deformed state suitably acts on the first terminal 120. In addition, when emphasis is placed on strength for avoiding breakage of the second terminal 140 at the time of elastic deformation or at the time of restoration deformation on the operation of the safety valve, the thickness of the second terminal 140 may be 0.03 mm or more, 0.05 mm or more, or 0.07 mm or more.

The second terminal 140 includes a first surface 140a facing the first terminal 120 side and a second surface 140b located on the opposite side of the first surface 140a. The second terminal 140 is fixed to the first surface 120a of the first terminal in a state of being elastically deformed toward the inside of the exterior body 50, thereby being electrically connected to the first terminal 120. More specifically, the second terminal 140 includes an outer peripheral part 144 and a central part 142 surrounded by the outer peripheral part 144, and the central part 142 of the second terminal is fixed to a part on the inner peripheral side of the thinned part 126 of the first terminal (namely, the central part 122 of the first terminal) in a state of being elastically deformed to be recess toward the inside of the exterior body 50, thereby being held in a state of being elastically deformed. In such a structure, the central part 142 of the second terminal is positioned on a relatively inner side the exterior body 50 with respect to the outer peripheral part 144 of the second terminal. In other words, the outer peripheral part 144 of the second terminal is positioned relatively outside the central part 142 of the second terminal in the battery axis direction.

With the structure described above, the second terminal 140 is fixed in a state where the central part 142 is elastically deformed toward the first terminal 120. While a restoring force to return from the elastically deformed state to the original state acts on the central part 142 of the second terminal, the elastically deformed state of the second terminal 140 is held by the fixed part 150 between the first terminal 120 and the second terminal 140. Therefore, the central part 122 of the first terminal to which the second terminal 140 is fixed receives a force with which the central part 142 of the second terminal intends to displace from a state where the central part 142 is elastically deformed toward the inside of the exterior body 50 toward the direction toward the outside of the exterior body 50, which is the opposite direction. In short, in a state where the second terminal 140 is fixed, a force with which the central part 122 of the first terminal is pulled toward the outside of the exterior body 50 by the second terminal 140 acts on the central part 122 of the first terminal. This action assists the cleavage of the first terminal 120 when the internal pressure of the battery increases. That is, according to the present disclosure, a battery including a safety valve capable of more suitably cutting a current at the time of abnormality can be provided.

The first terminal 120 and the second terminal 140 are preferably fixed to such an extent that the fixation is not released along with the operation of the safety valve also when the internal pressure of the battery increases. For example, it is preferable that the fixed part 150 is firmly fixed to such an extent that the first terminal 120 and the second terminal 140 are not unfixed along with the displacement of the second terminal 140. Furthermore, the fixed part 150 preferably contributes to electrical conduction between the first terminal 120 and the second terminal 140. That is, the first terminal 120 and the second terminal 140 may be electrically conducted with the fixed part 150 interposed therebetween. The first terminal 120 and the second terminal 140 may be fixed by, for example, laser welding or the like.

The fixed part 150 between the first terminal 120 and the second terminal 140 is positioned on the inner peripheral side with respect to the thinned part 126. The fixed part 150 may be positioned closer to the thinned part 126 than to the battery axis P. Preferably, the fixed part 150 is positioned along the thinned part 126 on the inner peripheral side with respect to the thinned part 126. That is, the fixed part 150 is preferably provided at a position closer to the thinned part 126. As a result, the restoring force of the second terminal 140 easily acts on the thinned part 126 of the first terminal. Therefore, when the internal pressure of the battery increases and the first terminal 120 is cleaved at the thinned part 126, the cleavage can be more suitably promoted by the restoring force of the second terminal 140.

For example, the first terminal 120 and the second terminal 140 may be fixed at a plurality of positions on the inner peripheral side with respect to the thinned part 126. When the fixed parts 150 are provided at a plurality of positions, the fixed parts 150 are preferably positioned to be point-symmetric about the battery axis P. For example, the safety valve may include four or more, six or more, or eight or more fixed parts 150 to be point-symmetric about the battery axis P. With such a structure, since the restoring force of the second terminal 140 acts more uniformly on the first terminal 120, the first terminal 120 can be cleaved more reliably and the current can be cut off when the internal pressure increases.

The fixed part 150 between the first terminal 120 and the second terminal 140 may be intermittently positioned along the thinned part 126 on the inner peripheral side with respect to the thinned part 126. Alternatively, the fixed part 150 may continuously extend along the thinned part 126 on the inner peripheral side with respect to the thinned part 126. That is, the fixed part 150 may be provided in a substantially annular shape to correspond to the plan-viewed shape of the thinned part 126. Here, the term “substantially annular” is not necessarily limited to a continuous annular shape in which the entire circumference is fully closed, and includes a discontinuous annular shape having a cut in part. As a result, the second terminal 140 is more reliably fixed to the first terminal 120, so that the central part 142 of the second terminal can be suitably held in an elastically deformed state in a normal state in which the internal pressure of the battery does not increase.

A non-fixed region where the first terminal 120 and the second terminal 140 are not fixed may be provided on the inner peripheral side with respect to the thinned part 126. In other words, the first terminal 120 and the second terminal 140 may be fixed in a partial region on the inner peripheral side with respect to the thinned part 126. That is, the central part 122 on the inner peripheral side with respect to the thinned part 126 may include a fixed part 150 where the first terminal 120 and the second terminal 140 are fixed, and a non-fixed region where the first terminal 120 and the second terminal 140 are not fixed. When the first terminal 120 and the second terminal 140 are fixed in the entire region of the central part 122, the elastically deformed second terminal 140 is firmly fixed, and the restoring force can be suppressed. This possibly suppresses the action of promoting cleavage when the internal pressure of the battery increases. On the other hand, owing to including the non-fixed region, it is possible to avoid the second terminal 140 from being excessively firmly fixed. Therefore, when the internal pressure of the battery increases while the second terminal 140 is held in an elastically deformed state in a normal state, the restoring force of the second terminal 140 can be suitably used in the cleavage of the first terminal 120.

Preferably, the non-fixed region may be positioned on the battery axis P. That is, the non-fixed region may be positioned with the battery axis P as the center, and the fixed part 150 between the first terminal 120 and the second terminal 140 may be positioned around the non-fixed region. In other words, the fixed part 150 between the first terminal 120 and the second terminal 140 may be provided on the outer peripheral side with respect to the non-fixed region positioned on the battery axis P. With such a configuration, the fixed part 150 is positioned closer to the thinned part 126 than the non-fixed region. The restoring force duo to the second terminal 140 toward the outside of the exterior body 50 acts more on the fixed part 150 than on the non-fixed region. Owing to the fact that the fixed part 150 is positioned proximal to the thinned part 126, the restoring force of the second terminal 140 can be more efficiently applied to the thinned part 126. Therefore, when the internal pressure of the battery increases, the first terminal 120 can be more suitably cleaved.

As described above, the safety valve of the present disclosure cleaves and divides the first terminal 120 by the increased internal pressure and the restoring force of the second terminal 140 when the internal pressure of the battery increases during an abnormality such as overcharge. It is preferable that the battery including the safety valve of the present disclosure is sealed in order to increase the internal pressure by the gas generated inside and quickly operate the safety valve. Since the exterior body 50 is opened at the opening formed at one end, the battery is preferably sealed with a safety valve. In other words, the safety valve may seal the opening to seal the inside of the battery.

An insulating member 130 may be disposed between the first terminal 120 and the second terminal 140 on the outer peripheral side with respect to the thinned part 126. That is, the first terminal 120 and the second terminal 140 may be disposed to sandwich the insulating member 130 on the outer peripheral side with respect to the thinned part 126. The plan-viewed shape of the insulating member 130 may be a loop shape, a ring shape, or the like. The insulating member 130 may include a through hole 132 positioned on the battery axis P. In plan view, the through hole 132 may have a hole shape corresponding to the plan-viewed shape of the central part 122 of the first terminal. The insulating member 130 may be positioned on the outer peripheral side with respect to the thinned part 126, and the second terminal 140 may be elastically deformed toward the first terminal 120 to straddle the insulating member 130 via the through hole 132 of the insulating member 130 on the inner peripheral side with respect to the thinned part 126, and may be electrically connected to the first terminal 120. That is, the first terminal 120 and the second terminal 140 are connected on the inner peripheral side with respect to the thinned part 126, and are separated by the insulating member 130 on the outer peripheral side with respect to the thinned part 126. With such a configuration, in a state where the safety valve is operated and the first terminal 120 is divided, the first terminal 120 and the second terminal 140 are electrically insulated by the insulating member 130 on the outer peripheral side with respect to the thinned part 126, and thus, it is possible to suitably cut off the electrical conduction between the battery assembly 10 and the second terminal 140.

The “Insulation” referred to in the present specification may have the insulation property of common insulators, and thus have the electrical resistivity of the common insulators. The “insulative” member may have an electrical resistivity (room temperature: 20° C.) of at least 1.0×10⁵ Ω·m or more, preferably 1.0×10⁶ Ω·m or more, and more preferably 1.0×10⁷ Ω·m or more although it is merely an example.

The insulating member 130 may be an insulative resin member. The insulating member 130 preferably contains a resin component. Owing to this, suitable insulation property (particularly, electrical insulation property) is provided between the outer peripheral part 124 of the first terminal and the outer peripheral part 144 of the second terminal. When more emphasis is placed on exhibiting suitable resistance to undesired heat at the time of battery abnormality, the insulating member 130 preferably contains a resin superior in heat resistance. For example, the insulating member 130 may be made of a thermosetting resin, a thermoplastic resin, and/or a UV curable resin. The specific resin component of the insulating member 130 is not particularly limited, and examples thereof include at least one selected from the group consisting of polyethylene resin, polypropylene resin, polystyrene resin, ABS resin (acrylonitrile (A)-butadiene (B)-styrene(S) resin), vinyl chloride resin, polymethyl methacrylate resin, polyethylene terephthalate resin, polyamide resin, polycarbonate resin, polyacetal resin, a polybutylene terephthalate resin, a modified polyphenylene ether resin, polyphenylene sulfide resin, liquid crystal polymers, polyarylate resin, polysulfone resin, polyether sulfone resin, polyether ether ketone resin, and the like.

The insulating member 130 may be adhered to each of the outer peripheral parts 124 and 144 of the first terminal and the second terminal. Specifically, the insulating member 130 may be adhered to each of the outer peripheral part 124 of the second surface 120b of the first terminal 120 and the outer peripheral part 144 of the first surface 140a of the second terminal. The outer peripheral parts of the first terminal 120 and the second terminal 140 can be fixed to each other by the adhesion. In particular, owing to the fact that the outer peripheral part 144 of the second terminal is fixed by adhering to the insulating member 130, when the internal pressure of the battery increases, the restoring force can more efficiently act on the central part 142 of the elastically deformed second terminal. Therefore, when the internal pressure of the battery increases, the first terminal 120 can be cleaved and divided more reliably.

Further, the adhesion between the insulating member 130 and each of the first terminal 120 and the second terminal 140 may contribute to sealing between the insulating member 130 and the first terminal 120 and between the insulating member 130 and the second terminal 140. For example, the adhesion may be performed by the adhesive layers 160 provided between the insulating member 130 and the first terminal 120 and between the insulating member 130 and the second terminal 140, and the insulating member 130 and each of the first terminal 120 and the second terminal 140 may be sealed by the adhesive layers 160. With such a structure, at the time of abnormality such as overcharge, it is possible to suitably operate the safety valve by prevent gas generated inside from immediately leaking to the outside and by increasing the internal pressure of the battery.

The adhesive layer 160 positioned in the insulating member 130 may be a thermoplastic resin. That is, an interface between the insulating member 130 and the outer peripheral part 124 of the first terminal, an interface between the insulating member 130 and the outer peripheral part 144 of the second terminal, and/or an interface between the insulating member 130 and the exterior body 50 each may be fixed by a thermoplastic resin. As described above, when an abnormality of the increase in the internal pressure occurs due to overcharge or the like inside the battery due to a short circuit or the like, it is conceivable that the abnormality occurs in combination with such an abnormality as an increase in the battery temperature, for example. That is, in addition to an increase in pressure inside the battery due to side reactions such as a decomposition reaction of the electrolytic solution or other factors, undesired temperature increase inside the battery may occur. In a structure in which a thermoplastic resin is disposed between the insulating member 130 and the first terminal 120, between the insulating member 130 and the second terminal 140, and/or between the insulating member 130 and the exterior body 50, when the temperature of the battery rises, the thermoplastic resin can flow. At this time, since the internal pressure of the battery is increased by the gas generated inside the battery, the gas filled inside the battery can leak to the outside by pushing away the thermoplastic resin that has become flowable due to the high temperature. That is, the thermoplastic resin disposed between the insulating member 130 and a terminal can contribute as a degassing mechanism (or a vent mechanism) for releasing the internal pressure by releasing the gas accumulated in the battery and avoiding bursting of the battery when the internal pressure of the battery increases and further the temperature of the battery increases. As a result, a safety valve including not only a current cutoff mechanism but also a degassing mechanism can be provided.

Examples of the thermoplastic resin include at least one selected from the group consisting of polyethylene resin, polypropylene resin, polystyrene resin, ABS resin (acrylonitrile (A)-butadiene (B)-styrene (S) resin), vinyl chloride resin, polymethyl methacrylate resin, polyethylene terephthalate resin, polyamide resin, polycarbonate resin, polyacetal resin, a polybutylene terephthalate resin, a modified polyphenylene ether resin, polyphenylene sulfide resin, liquid crystal polymers, polyarylate resin, polysulfone resin, polyether sulfone resin, polyether ether ketone resin, and the like.

The insulating member 130 is preferably made of a material superior in heat resistance to the thermoplastic resin to be used as the adhesive layer. More specifically, the insulating member 130 is preferably made of a material that is less likely to be softened under high temperature conditions than the adhesive layer 160. This makes it possible to suitably maintain electrical insulation between the outer peripheral part 124 of the first terminal and the outer peripheral part 144 of the second terminal also at a high temperature.

The insulating member 130 is located on the outer peripheral side with respect to the thinned part 126 of the first terminal, and may extend from the thinned part 126 to an edge part 57 forming a boundary between the end face 52 and the side surface 58 of the exterior body. In an embodiment, the insulating member 130 may be provided to extend from the thinned part 126 to the side surface 58 of the exterior body. In such a structure, the insulating member 130 is provided to cover the edge part 57 extending between the end face 54 and the side surface 58 of the exterior body.

In an embodiment in which the insulating member 130 is provided to extend to the side surface 58 of the exterior body, the insulating member 130 may be adhered to the side surface 58 of the exterior body (see FIG. 8). That is, the insulating member 130 and the side surface 58 of the exterior body may be adhered to each other. With such a structure, the insulating member 130 can be suitably fixed to the exterior body 50 also when the internal pressure of the battery increases. Therefore, the insulating member 130 can suitably suppress the risk that the safety valve is blown off due to the increase in the internal pressure, and can suitably fix the safety valve to the exterior body 50.

The insulating member 130 and the side surface 58 of the exterior body may be adhered to each other by the thermoplastic resin described above. That is, a thermoplastic resin may be disposed between the insulating member 130 and the side surface 58 of the exterior body, and the insulating member 130 may be fixed to the exterior body 50 by the thermoplastic resin. Owing to disposing the thermoplastic resin, when the temperature of the battery becomes high due to abnormal heat generation or the like, the gas generated in the battery can be suitably released from the portion of the thermoplastic resin where the fluidity is increased by the high temperature.

In an embodiment, the sealing member 110 disposed between the exterior body 50 and the first terminal 120 may be made of, for example, a thermosetting resin, a thermoplastic resin, and/or a UV curable resin. In particular, the sealing member 110 may be a thermoplastic resin when emphasis is placed on gas release properties when the battery reaches a high temperature. Thanks to the use of a thermoplastic resin as the sealing member 110, the sealing member 110 can be softened when the battery reaches an undesired high temperature. Thereafter, the gas inside the battery is released to the outside in such a manner that the gas pushes away the softened sealing member 110, and the internal pressure of the gas can be released.

As described above, the battery of the present disclosure may include a safety valve including both a current cutoff mechanism by cleavage and division of the first terminal 120 and a degassing mechanism by adhesion using a thermoplastic resin. Of the two mechanisms, the current cutoff mechanism uses a force that pushes up the first terminal 120 toward the outside of the exterior body as the internal pressure of the battery increases, in addition to the restoring force by the second terminal 140. Therefore, when the degassing mechanism operates before the current cutoff mechanism operates, there is a possibility that the internal pressure of the battery does not increase to a prescribed pressure necessary for cleavage and division of the first terminal 120, so that the current cutoff mechanism does not normally operate. Therefore, it is preferable that the inside of the battery is sealed until the current cutoff mechanism operates (namely, until at least the thinned part 126 of the first terminal is cleaved). In particular, when an abnormality occurs in the battery at room temperature and the internal pressure of the battery increases, it is preferable that the safety valve operates in the order of (i) cleavage of the first terminal 120 in the thinned part 126, (ii) displacement of the elastically deformed second terminal 140 toward the outer side of the exterior body, and (iii) degassing from the adhered part. Therefore, it is preferable that the internal pressure of the exterior body 50 required for the cleavage of (i), the displacement of (ii), and the degassing of (iii) is designed to satisfy the order of (i)<(ii)<(iii).

According to the present disclosure, the safety valve can be disposed on the end face 54 of the exterior body having an opening to cover the opening. That is, in the battery of the present disclosure, the safety valve can be disposed on the opening such that a lid is put over the opening. In such a structure, the safety valve is positioned on the outer side of the exterior body 50. With such a configuration, a space where the safety valve is disposed can be omitted inside the exterior body 50. Therefore, a larger battery assembly can be disposed inside the exterior body 50, and the energy density per volume of the battery can be improved. That is, according to the present disclosure, since the safety valve can be included without reducing the capacity of a battery, a battery suitable in terms of battery capacity and safety can be provided.

In a conventional safety valve structure, a safety valve is disposed on an exterior body including a beading part 56 (see FIG. 9) formed over the outer periphery of the exterior body side surface 58. The “beading part” refers to a part constricted toward the battery axis P side on the side surface 58 of the exterior body. In other words, the “beading part” is a part that is constricted to protrude toward the inside of the exterior body, and can also be referred to as “constricted part” or a “narrowed portion”. Conventionally, in a battery including an exterior body having a beading part, a support member such as a gasket is disposed in the beading part, and a safety valve is held inside the exterior body with the gasket part interposed therebetween (WO 2020/111275 A). That is, the conventional safety valve is disposed inside the exterior body including the beading part.

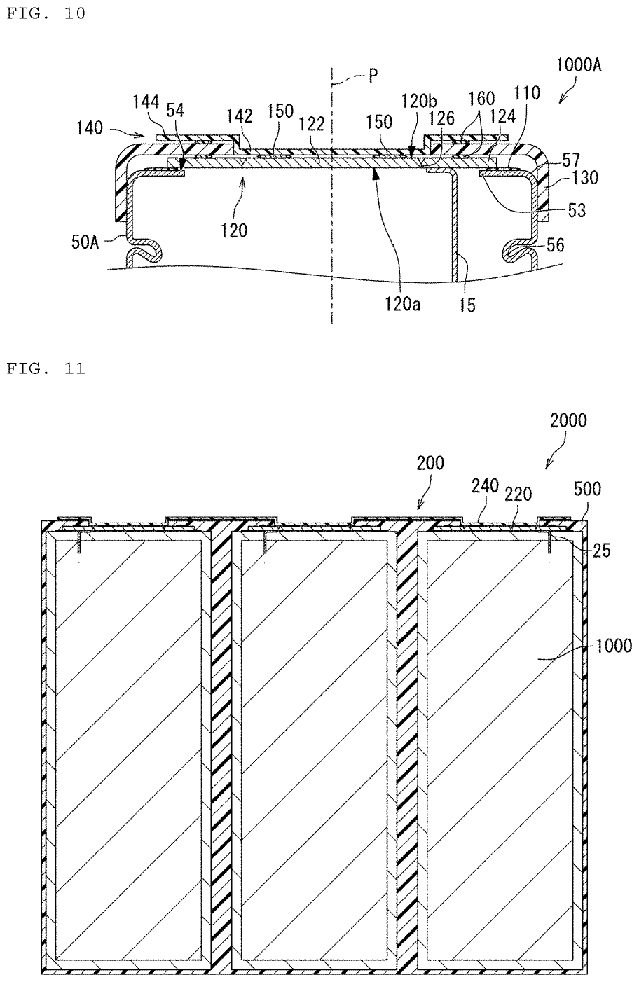

On the other hand, according to the present disclosure, since the safety valve can be disposed on the outer side of the exterior body, the safety valve can be disposed without requiring any support member such as a gasket. Therefore, a battery having a simpler structure and including a safety valve can be provided. Furthermore, according to the present disclosure, the safety valve can be disposed without any support by the beading part 56. Therefore, the safety valve can be disposed not only on the exterior body including the beading part 56 but also on the exterior body not including the beading part (see FIG. 5). That is, according to the present disclosure, the safety valve can be suitably disposed regardless of the presence or absence of the beading part. In the exterior body 50, the inner diameter dimension of the exterior body 50 may be substantially constant along the battery axis P. Therefore, the exterior body 50 can secure a wider internal space of the exterior body in which a battery assembly can be disposed as compared with the exterior body 50 having the beading part 56 (see FIGS. 9 and 10). That is, according to the present disclosure, since the safety valve can be disposed also on a beading part-free exterior body which enables high energy density, a battery having high energy density and being superior in safety can be obtained.

In the exterior body 50, the end face 54 of the exterior body to which the safety valve 100 is attached may be a cover member 54A attached to one end part of the exterior body 50 by welding, adhesion, or the like. Specifically, the exterior body 50 including no beading part may include a cylindrical body 55 including an open end part at which one end is opened, and the end face 54 of the exterior body may be formed by attaching a cover member 54A including an opening to the open end part. With such a structure, the cover member 54A is also regarded as a member that supports the safety valve at the end part of the exterior body, and therefore can also be referred to as a support member or the like. The cover member 54A may be either a conductive member or an insulative resin member.

A method of manufacturing a secondary battery will be described in an exemplary manner. The secondary battery of the present disclosure can be manufactured by the following procedure, for example.

In the preparation of a positive electrode, a positive electrode mixture is obtained by mixing a positive electrode active material with a positive electrode binder, a positive electrode conductor, and the like as necessary. Subsequently, the positive electrode mixture is dispersed in an organic solvent or the like to afford a positive electrode mixture slurry. Subsequently, the positive electrode mixture slurry is applied to one side or both sides of a positive electrode current collector and then dried to form a positive electrode active material layer. Thereafter, the positive electrode active material layer may be compression-molded using a roll press or the like, if necessary. In this case, the positive electrode active material layer may be heated, and compression molding may be repeated multiple times. In the same manner, a negative electrode can be produced. Specifically, the negative electrode active material, and, for example, a negative electrode positive electrode binder and the negative electrode conductive agent are mixed to afford a negative electrode mixture. Subsequently, the negative electrode mixture is dispersed in, for example, an organic solvent to afford a paste negative electrode mixture slurry. Subsequently, the negative electrode mixture slurry is applied to one side or both sides of the negative electrode current collector, and the negative electrode mixture slurry is dried, thereby forming a negative electrode active material layer. Thereafter, the negative electrode active material layer is compression-molded using a roll press or the like, if necessary.

In assembling a secondary battery, a positive electrode lead is connected to the positive electrode current collector by a welding method or the like as well as a negative electrode lead is connected to the negative electrode current collector by a welding method or the like. Subsequently, the positive electrode and the negative electrode are stacked with a separator interposed therebetween, and then, the positive electrode, the negative electrode, and the separator are wound to form a wound electrode body. Subsequently, a center pin is inserted in the winding space of the wound electrode body. Then, the wound electrode body is sandwiched between paired insulating plates, and the wound electrode body is housed inside an exterior body together with the paired insulating plates. In this case, one end of the positive electrode lead is connected to an outer peripheral part 124 of a first terminal of a safety valve by a welding method or the like, and one end of the negative electrode lead is connected to the exterior body similarly by a welding method or the like. Subsequently, an electrolytic solution is injected into the exterior body to impregnate the wound electrode body with the electrolytic solution. The safety valve is formed by combining the sealing member, the first terminal, the insulating member, and the second terminal in this order. At this time, an adhesive layer is disposed between the first terminal and the insulating member and between the second terminal and the insulating member, and the members are adhered to each other. After the members are combined, the central part 142 of the second terminal is pressed toward the central part 122 of the first terminal to be elastically deformed. Subsequently, the second terminal is fixed to the first terminal in an elastically deformed state by a welding method or the like. The safety valve combined in this manner is disposed on the opening of the exterior body to seal the exterior body. Thereby, a secondary battery provided with the safety valve is completed.

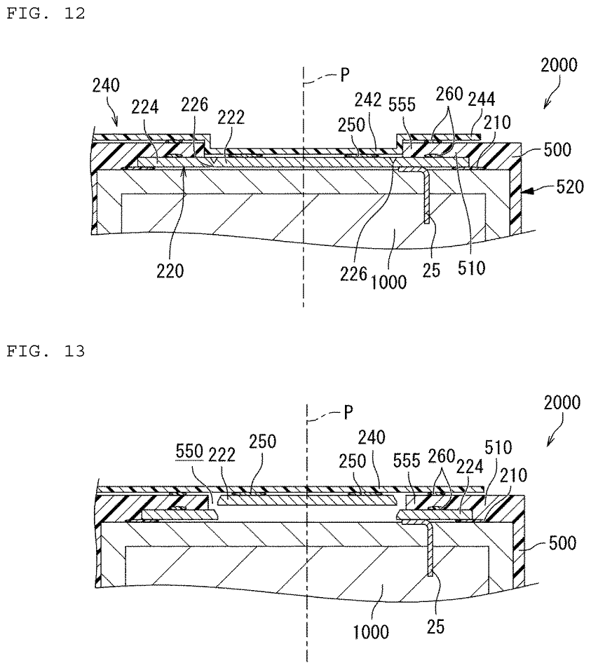

Next, a configuration example of a battery pack will be described with reference to drawings. FIG. 11 is a schematic sectional view of a battery pack according to an embodiment of the present disclosure. FIG. 12 is an enlarged sectional view schematically illustrating the structure of the safety valve before operation in the battery pack of the present disclosure. FIG. 13 is an enlarged sectional view schematically illustrating the structure of the safety valve after operation in the battery pack of the present disclosure.

The battery pack 2000 includes at least a battery 1000 and a battery holder 500 that houses the battery 1000. The battery 1000 housed in the battery holder 500 may be electrically connected to a terminal included in the safety valve attached to the battery holder 500 with a conductive member 25 interposed therebetween, such as a conductive lead extending from a terminal (not shown) of the battery 1000.

The battery holder 500 may be an insulative resin member. Although merely being an example, the battery holder 500 may include any one of, or two or more of resin materials such as polypropylene (PP) and polycarbonates.

For example, the battery pack 2000 may house a single battery 1000 or may include two or more batteries 1000. One battery 1000 may be housed in one battery holder 500. When the battery pack 500 includes two or more batteries 1000, two or more battery holders 500 may be connected to each other. Alternatively, one battery holder 500 may be configured to be able to house a plurality of batteries 1000. The plurality of batteries 1000 housed in battery holder 500 may be connected in series and/or in parallel by a connection plate (not shown) installed outside the battery holder 500.

The structure of the safety valve of the battery as described above can also be applied as a safety valve provided in a battery holder of a battery pack. For example, the battery holder 500 may include a terminal plate functioning as a safety valve as a terminal plate electrically connected to one terminal of the battery 1000 housed in the battery holder 500. The battery holder 500 includes an opening 550 that is released in part. The safety valve 200 including a terminal plate may be provided to cover the opening 550. The safety valve 200 may be provided on the outer side of the battery holder 500. The safety valve 200 includes a first terminal plate 220 located relatively closer to the battery holder 500 and a second terminal plate 240 located relatively closer to the outside of the battery pack 550. The first terminal plate 220 includes a thinned part 226 present on the inner peripheral side relative to the opening end 555 of the opening 550 of the battery holder. The first terminal plate 220 is electrically connected to the battery 1000 in the battery holder 500 on the outer peripheral side with respect to the thinned part 226, and is electrically connected to the second terminal plate 240 on the inner peripheral side with respect to the thinned part 226. The second terminal plate 240 is fixed to the first terminal plate 220 in a state of being elastically deformed toward the inside of the battery holder 500 on the inner peripheral side with respect to the thinned part 226, thereby being electrically connected to the first terminal plate 220. That is, the battery 1000 housed in the battery holder 500 is electrically connected to the second terminal plate 240 with the thinned part 226 of the first terminal plate interposed therebetween.

With the structure described above, when an abnormality occurs in the battery 1000 housed in the battery holder 500 and the internal pressure of the battery holder 500 rises due to generation of an undesired gas, the first terminal plate 220 can be cleaved and divided at the thinned part 226 by the action of both the internal pressure and the restoring force of the elastically deformed second terminal plate 240. Thereby, the electrical connection between the battery 1000 in the battery holder 500 and the second terminal 240 located outside the battery holder 500 can be cut off.

The battery holder 500 may include an end face 510 around the opening 550. The end face 510 can also be interpreted as an overhanging face extending to overhang from the side surface 520 of the battery holder toward the opening 550, and can also be referred to as “end face overhanging part” or the like. On the outer peripheral side with respect to the thinned part 226, the end face 510 of the battery holder may be interposed between the first terminal plate 220 and the second terminal plate 240. That is, on the outer peripheral side with respect to the thinned part 226, the first terminal plate 220 and the second terminal plate 249 may be electrically insulated by the battery holder 500. Owing to this configuration, also after the first terminal plate 220 is divided, the current between the first terminal plate 220 and the second terminal plate 240 can be reliably cut off.

The end face 510 of the battery holder disposed between the first terminal plate 220 and the second terminal plate 240 may be adhered to each of the first terminal plate 220 and the second terminal plate 240 by an adhesive layer 260 such as resin. Owing to this configuration, the first terminal plate 220 and the second terminal plate 240 are suitably held with respect to the battery holder 500. Therefore, when the internal pressure of the battery holder 500 increases, the current can be suitably cut off by the cleavage in the thinned part 226 of the first terminal plate and the displacement of the central part 242 of the second terminal plate without detaching the first terminal plate 220 and the second terminal plate 240 from the battery holder 500.

The safety valve 200 of the present disclosure cuts off the current through cleavage and division of the first terminal plate 220 as the internal pressure of the battery holder 500 increases. In order to appropriately operate such a safety valve 200, it is preferable that the battery holder 500 is sealed so that a gas does not leak to the outside before the operation of the safety valve 200. For example, the battery holder 500 may be sealed by the safety valve 200.

The adhesive layer 260 disposed on the end face 510 of the battery holder may be a thermoplastic resin. Thanks to the use of a thermoplastic resin as the adhesive layer 260, when the temperature of the battery 1000 becomes abnormally high, the adhesive layer 260, which is the thermoplastic resin, is heated, so that the fluidity of the adhesive layer 260 increases. Therefore, when the battery pack 2000 reaches a high temperature and the internal pressure of the battery holder 500 increases, the gas in the battery holder 500 is released to the outside in such a manner that the adhesive layer 260 made of the thermoplastic resin is pushed away. As a result, the internal pressure in the battery holder 500 can be suitably released.

In the battery pack in which a plurality of battery holders 500 are connected, the battery holders 500 may include a plurality of openings 550. In such a structure, the safety valve 200 may be disposed in each of the plurality of openings 510. That is, the battery pack may include a plurality of safety valves 200. When the plurality of safety valves 200 are provided, the plurality of safety valves 200 adjacent to each other may share the second terminal 240. That is, the second terminal 240 may be continuous to straddle the plurality of safety valves 200 adjacent to each other. Alternatively, the second terminals 240 of the plurality of adjacent safety valves may be electrically connected to each other with a connecting member (not shown) interposed therebetween.

Although the aspects of the present disclosure have been described above, only typical examples have been illustrated and the present disclosure is not limited thereto, and various embodiments are conceivable without changing the scope of the present disclosure.

It is to be noted that an embodiment of the present disclosure as described above encompasses the following preferable aspects.

<1>

A battery including: a battery assembly; an exterior body that has an opening at one end and houses the battery assembly; and a safety valve disposed at the opening,
in which the safety valve includes an inner terminal positioned relatively inside and an outer terminal positioned relatively outside,
the inner terminal includes an annular-in-plan-view thinned part located on an inner peripheral side with respect to an opening end of the opening, and is electrically connected to the battery assembly on an outer peripheral side with respect to the thinned part, and
the outer terminal is fixed to the inner terminal in a state of being elastically deformed toward the inside of the exterior body on an inner peripheral side with respect to the thinned part, and is electrically connected to each other.
   <2>

The battery of <1>, in which the thinned part is positioned between a connection part of the inner terminal with the battery assembly and a fixed part to the outer terminal in the inner terminal.

<3>

The battery of <1> or <2>, in which the battery assembly and the outer terminal are electrically connected to each other with the thinned part of the inner terminal interposed therebetween.

<4>

The battery of any one of <1> to <3>, in which the opening is sealed by the safety valve in a normal state.

<5>

The battery of any one of <1> to <4>, in which the safety valve is provided on an outer side of the exterior body.

<6>

The battery of any one of <1> to <5>, further including an insulating member disposed between the inner terminal and the outer terminal on an outer peripheral side with respect to the thinned part.

<7>

The battery according to <6>, in which the insulating member is bonded to each of the inner terminal and the outer terminal on an outer peripheral side with respect to the thinned part.

<8>

The battery according to <7>, in which the insulating member is bonded to each of the inner terminal and the outer terminal with a thermoplastic resin interposed therebetween.

<9>

The battery according to <6>, in which the exterior body includes a side part continuous with the one end, and
the insulating member extends to the side part of the exterior body.
   <10>

The battery according to <9>, in which the exterior body and the insulating member are bonded to each other on the side part with a thermoplastic resin interposed therebetween.

<11>

The battery according to any one of <1> to <10>, in which the outer terminal includes an outer peripheral part and a central part surrounded by the outer peripheral part, and the central part is located relatively on an inner side of the exterior body with respect to the outer peripheral part.

<12>

The battery of any one of <1> to <11>, in which a fixed part between the inner terminal and the outer terminal is provided on an inner peripheral side with respect to the thinned part, and
the fixed part is positioned closer to the thinned part than to a battery axis.
   <13>

The battery of <12>, in which the fixed part extends continuously along the thinned part.

<14>

The battery of <12>, in which a plurality of the fixed parts is provided, and
the plurality of fixed parts is positioned so as to be point-symmetric about the battery axis in plan view.
   <15>

The battery according to any one of <1> to <14>, further including a non-fixed region where the inner terminal and the outer terminal are not fixed on an inner peripheral side of the thinned part.

<16>

The battery of <15>, in which the non-fixed region is positioned on the battery axis.

<17>

The battery according to any one of <1> to <16>, including a sealing member disposed between the exterior body and the inner terminal on an outer peripheral side with respect to the thinned part,
in which the sealing member is of a thermoplastic resin.
   <18>

The battery of any one of <1> to <17>, in which the exterior body has a structure including no beading part.

<19>

A battery pack including: a battery; and a battery holder that houses the battery,
in which the battery holder includes an opening and a safety valve provided in the opening,
the safety valve includes an inner terminal located relatively on an inner side of the battery holder, and an outer terminal located relatively on an outer side of the battery holder,
the inner terminal includes a thinned part extending on an inner peripheral side with respect to an opening end of the opening, and is electrically connected to the battery on an outer peripheral side with respect to the thinned part, and
the outer terminal is fixed to the inner terminal in a state of being elastically deformed toward the inside of the battery holder on an inner peripheral side with respect to the thinned part.
   <20>

The battery pack of <19>, in which the opening of the battery holder is sealed by the safety valve.

<21>

The battery pack according to <19> or <20>, in which the battery holder includes an end face extending to an outer peripheral side of the opening, and
the end face is adhered to each of the inner terminal and the outer terminal on an outer peripheral side with respect to the thinned part.
   <22>

The battery pack of any one of <19> to <21>, in which the battery holder has a plurality of the openings, and
the safety valve is provided in each of the plurality of openings.

Note that the effects and the like described herein are intended to be mere examples. Therefore, the present disclosure is not limited thereto, and may have an additional effect.

The batteries (batteries such as a primary battery and a secondary battery) according to the present disclosure can be used typically for applications in which use of electric energy is required. For example, the secondary battery according to the present disclosure can be used in various fields in which storage of electricity is assumed. As a mere example, the battery of the present disclosure can be used in the fields of electricity, information, and communication in which electricity, electronic equipment, and the like are used (for example, electric and electronic equipment fields or mobile equipment fields including mobile phones, smartphones, notebook computers and digital cameras, activity meters, arm computers, electronic paper, wearable devices, and small electronic machines such as RFID tags, card type electronic money, and smartwatches), home and small industrial applications (for example, the fields of electric tools, golf carts, and home, nursing, and industrial robots), large industrial applications (for example, the fields of forklift, elevator, and harbor crane), transportation system fields (for example, the fields of hybrid vehicles, electric vehicles, buses, trains, power-assisted bicycles, electric two-wheeled vehicles), power system applications (for example, the fields of various types of power generation, road conditioners, smart grids, and household power storage systems), medical applications (medical equipment fields such as earphone hearing aids), pharmaceutical applications (fields such as dosage management systems), IoT fields, space and deep sea applications (for example, the fields of a space probe and a submersible), and the like.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising: a battery assembly; an exterior body that has an opening at one end and houses the battery assembly; and a safety valve disposed at the opening,
wherein the safety valve includes an inner terminal positioned relatively inside and an outer terminal positioned relatively outside,
the inner terminal includes an annular-in-plan-view thinned part located on an inner peripheral side with respect to an opening end of the opening, and is electrically connected to the battery assembly on an outer peripheral side with respect to the thinned part, and
the outer terminal is fixed to the inner terminal in a state of being elastically deformed toward the inside of the exterior body on an inner peripheral side with respect to the thinned part, and is electrically connected to each other.

2. The battery according to claim 1, wherein the thinned part is positioned between a connection part of the inner terminal with the battery assembly and a fixed part to the outer terminal in the inner terminal.

3. The battery according to claim 1, wherein the battery assembly and the outer terminal are electrically connected to each other with the thinned part of the inner terminal interposed therebetween.

4. The battery according to claim 1, wherein the opening is sealed by the safety valve in a normal state.

5. The battery according to claim 1, wherein the safety valve is provided an outer side of the exterior body.

6. The battery according to claim 1, further comprising an insulating member disposed between the inner terminal and the outer terminal on an outer peripheral side with respect to the thinned part.

7. The battery according to claim 6, wherein the insulating member is bonded to each of the inner terminal and the outer terminal on an outer peripheral side with respect to the thinned part.

8. The battery according to claim 7, wherein the insulating member is bonded to each of the inner terminal and the outer terminal with a thermoplastic resin interposed therebetween.

9. The battery according to claim 6, wherein the exterior body includes a side part continuous with the one end, and
the insulating member extends to the side part of the exterior body.

10. The battery according to claim 9, wherein the exterior body and the insulating member are bonded to each other on the side part with a thermoplastic resin interposed therebetween.

11. The battery according to claim 1, wherein the outer terminal includes an outer peripheral part and a central part surrounded by the outer peripheral part, and
in sectional view, the central part is located relatively on an inner side of the exterior body with respect to the outer peripheral part.

12. The battery according to claim 1, wherein a fixed part between the inner terminal and the outer terminal is provided on an inner peripheral side with respect to the thinned part, and
the fixed part is positioned closer to the thinned part than to a battery axis.

13. The battery according to claim 12, wherein the fixed part extends continuously along the thinned part.

14. The battery according to claim 12, wherein a plurality of the fixed parts are provided, and
the plurality of fixed parts are positioned so as to be point-symmetric about the battery axis in plan view.

15. The battery according to claim 1, further including a non-fixed region where the inner terminal and the outer terminal are not fixed on an inner peripheral side with respect to the thinned part.

16. The battery according to claim 15, wherein the non-fixed region is positioned on the battery axis.

17. The battery according to claim 1, further including a sealing member disposed between the exterior body and the inner terminal on an outer peripheral side with respect to the thinned part,
wherein the sealing member includes a thermoplastic resin.

18. The battery according to claim 1, wherein the exterior body has a structure including no beading part.

19. A battery pack including: a battery; and a battery holder that houses the battery,
in which the battery holder includes an opening and a safety valve provided in the opening,
the safety valve includes an inner terminal located relatively on an inner side of the battery holder, and an outer terminal located relatively on an outer side of the battery holder,
the inner terminal includes a thinned part extending on an inner peripheral side with respect to an opening end of the opening, and is electrically connected to the battery on an outer peripheral side with respect to the thinned part, and
the outer terminal is fixed to the inner terminal in a state of being elastically deformed toward the inside of the battery holder on an inner peripheral side with respect to the thinned part.

20. The battery pack according to claim 19, wherein the opening of the battery holder is sealed by the safety valve.

21. The battery pack according to claim 19, wherein the battery holder includes an end face extending to an outer peripheral side of the opening, and
the end face is disposed between the inner terminal and the outer terminal on an outer peripheral side with respect to the thinned part.

22. The battery pack according to claim 19, wherein the battery holder has a plurality of the openings, and
the safety valve is provided in each of the plurality of openings.
